(19) United States
(12) Patent Application Publication
(10) Pub. No.: US 2023/0384760 A1
(43) Pub. Date: Nov. 30, 2023

(54) CONTROL DEVICE

(71) Applicant: Fanuc Corporation, Minamitsuru-gun, Yamanashi (JP)

(72) Inventor: Takuya Saitou, Minamitsuru-gun, Yamanashi (JP)

(73) Assignee: Fanuc Corporation, Minamitsuru-gun, Yamanashi (JP)

(21) Appl. No.: 18/033,223

(22) PCT Filed: Nov. 8, 2021
(86) PCT No.: PCT/JP2021/041016

§ 371 Date: Apr. 21, 2023

(30) Foreign Application Priority Data
Nov. 10, 2020 (JP) 2020-187222

(51) Int. Cl. G05B 19/409; G05B 19/414

(52) U.S. Cl. CPC G05B 19/409; G05B 19/414

(57) ABSTRACT

A control device includes: a data access logic storage unit that stores a data access logic used for performing at least any one of reference and update of data related to an industrial machine; a data management unit that, based on the data access logic, performs reference or update of data related to the industrial machine; an operation logic storage unit that stores an operation logic used for performing a control process of the industrial machine; an operation management unit that, based on the operation logic, performs an operation related to the industrial machine; and an interface unit that provides a common interface used for accessing the data management unit and the operation management unit.

### CROSS REFERENCE TO RELATED APPLICATIONS

This is the U.S. National Phase application of PCT/JP2021/041016, filed Nov. 8, 2021, which claims priority to Japanese Patent Application No. 2020-187222, filed Nov. 10, 2020, the disclosures of these applications being incorporated herein by reference in their entireties for all purposes.

### FIELD OF THE INVENTION

The present invention relates to a control device and, in particular, relates to a control device that enables data management or operation to be performed via the same interface.

### BACKGROUND OF THE INVENTION

Control devices control machines used in a wide variety of industries, which may be a machine tool, a robot, or a peripheral device, or the like used in a manufacturing site (Patent Literature 1 and the like). For example, such control devices control various machines including processing machines such as a three-axis control machine tool, a five-axis control machine tool, a milling processing machine, a lathe, a grinder, or a gear processing machine, tool changers such as a magazine storage type automatic tool changer (a drum storage type, a chain storage type, a matrix storage type, or the like), a turret type automatic tool changer, or a comb-blade type tool rest, a robot such as an articulated robot or a parallel link robot, or the like. Further, also when the same type of processing machines or tools changer are controlled, various tools such as drilling tools, milling cutters, or tapping tools are handled.

A control device has a number of functions so as to be compatible with specifications of such a wide variety of machines or specifications of such a wide variety of peripheral devices or tools. Since the supported scopes may differ for respective functions, machine manufacturers examine and select functions that will be required for implementing desired machine control.

Functions of a control device may often have different operation specifications or data configurations for each of the functions. Thus, the interface used for data access or operation may often differ in accordance with the selected functions.

Further, there are many machine manufacturers (or sometimes machine users) that have constructed their original tool management mechanisms by utilizing a macro variable, a PLC variable area, or the like for an element missing in the above function group. Such a mechanism may often have its original specification and interface on a machine manufacturer basis or on a machine basis.

### PATENT LITERATURE

Patent Literature 1: Japanese Patent Application Publication No. 2015-204615

### SUMMARY OF THE INVENTION

In a manufacturing site where industrial machines of various machine types or various machine manufacturers are mixed, machine groups having different settings for control devices or machine groups having their original tool management mechanisms are mixed. It is thus required to take different measures for respective machines when constructing a data collection system or setting the machine to cooperate with peripherals. This makes it difficult for an operator on site to utilize each facility.

Accordingly, there is a demand for a mechanism that enables transactions related to a wide variety of machines, peripheral devices, or accessories to be performed via a common interface.

The control device according to the present invention solves the above problem by standardizing interfaces that differ for respective industrial machines such as machine tools, robots, or peripheral devices used in a manufacturing site.

A control device according to the present invention manages a procedure of reference and setting of data related to industrial machines that differ for respective industrial machines (hereafter, referred to as a data access logic) and a procedure of operation performed on the industrial machines (hereafter, referred to as an operation logic). Then, when a transaction for performing data access or operation to and from the industrial machine is performed, the data access logic and the operation logic which are prepared for an industrial machine to be controlled are called via a common interface. The data access logic and the operation logic may be prepared for each of different accessories such as a tool attached to the industrial machine.

Further, one aspect of the present invention is a control device that controls an industrial machine, and the control device includes: a data access logic storage unit that stores at least one data access logic used for performing at least any one of reference and update of data related to the industrial machine; a data management unit that, based on the data access logic, performs at least any one of reference and update of the data related to the industrial machine; an operation logic storage unit that stores at least one operation logic used for performing a control process of the industrial machine; an operation management unit that, based on the operation logic, performs an operation related to the industrial machine; and an interface unit that provides a common interface used for accessing the data management unit and the operation management unit, and a function related to the industrial machine is available via the common interface.

One aspect of the present invention enables transactions related to a wide variety of machines, peripheral devices, or accessories to be performed via a common interface and enables easier utilization of a wide variety of facilities installed in a manufacturing site.

### BRIEF DESCRIPTION OF DRAWINGS

FIG. 1 is a schematic hardware configuration diagram of a control device according to one embodiment.

FIG. 2 is a schematic block diagram illustrating functions of the control device according to one embodiment.

FIG. 3 is a diagram illustrating an example of a data access logic storage unit.

FIG. 4 is a diagram illustrating an example of an operation logic storage unit.

### DETAILED DESCRIPTION OF EMBODIMENTS OF THE INVENTION

Embodiments of the present invention will be described below with reference to the drawings.

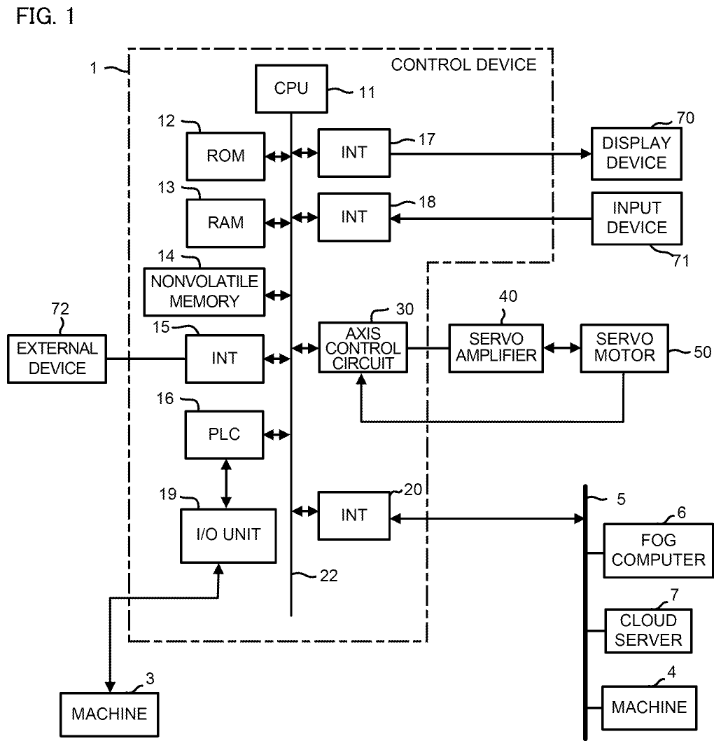

FIG. 1 is a schematic hardware configuration diagram illustrating a main part of a control device according to a first embodiment of the present invention. A control device 1 of the present invention can be implemented as a control device that controls a machine 3 based on a control program, for example.

A CPU 11 of the control device 1 according to the present embodiment is a processor that controls the control device 1 as a whole. The CPU 11 reads a system program stored in a ROM 12 via a bus 22 and controls the entire control device 1 in accordance with the system program. A RAM 13 temporarily stores temporary computation data or display data, various data that are externally input, and the like.

A nonvolatile memory 14 is formed of a memory backed up by a battery (not illustrated), a solid state drive (SSD), or the like, for example, and the storage state is held even when the control device 1 is powered off. The nonvolatile memory 14 stores a control program or data loaded from an external device 72 via an interface 15, a control program or data input from an input device 71 via an interface 18, a control program or data acquired from other machines to be controlled, a fog computer 6, a cloud server 7, or the like via a network 5, or the like. For example, the data stored in the nonvolatile memory 14 may include data related to a position, a speed, an acceleration, a load, an operation time of each motor in a machine, data related to each physical quantity sensed by a sensor (not illustrated) attached to other machines, or the like. Further, for example, the data stored in the nonvolatile memory 14 may include data related to a position, a speed, an acceleration, a load, an operation time of each motor in another machine to be controlled, data related to each physical quantity sensed by a sensor (not illustrated) attached to said another machine, or the like. The control program or data stored in the nonvolatile memory 14 may be loaded into the RAM 13 when executed and/or used. Further, in the ROM 12, various system programs such as a known analysis program are written in advance.

The interface 15 is an interface for connecting the CPU 11 of the control device 1 and the external device 72 of the external storage medium or the like to each other. A control program, setup data, or the like used for control of a machine, for example, are loaded from the external device 72 side. Further, a control program, setup data, or the like compiled inside the control device 1 can be stored in an external storage medium such as a CF card or a USB memory (not illustrated) via the external device 72. A programable logic controller (PLC) 16 executes a ladder program to output a signal to the machine 3 via an I/O unit 19 and control the machine 3 (for example, a tool changer, an actuator such as a robot, or a sensor such as a temperature sensor or a humidity sensor attached to the machine) that is controlled based on input/output signals. Further, the PLC 16 receives a signal from the machine 3, performs necessary signal processing thereon, and then passes the signal to the CPU 11.

An interface 20 is an interface for connecting the CPU of the control device 1 and the wired or wireless network 5 to each other. For example, the network 5 may perform communication by using a technology such as serial communication of RS-485 or the like, Ethernet (registered trademark) communication, optical communication, a wireless LAN, Wi-Fi (registered trademark), Bluetooth (registered trademark), or the like. Higher-level management devices such as another machine to be controlled, the fog computer 6, the cloud server 7, and the like are connected to the network 5 and transfer data to and from the control device 1 with each other.

On the display device 70, each data loaded on the memory, data obtained as a result of execution of a program or the like, or the like are output and displayed via an interface 17. Further, the input device 71 formed of a keyboard, a pointing device, or the like passes an instruction, data, or the like based on an operator's operation to the CPU 11 via the interface 18.

An axis control circuit 30 for controlling one or more axes of a machine receives a motion instruction value for an axis from the CPU 11 and outputs an instruction for the axis to a servo amplifier 40, respectively. The servo amplifier 40 receives this instruction and drives a servo motor 50 that moves a drive unit of a machine along an axis, respectively. The servo motor 50 for an axis has a built-in position and speed detector and feeds a position and speed feedback signal from the position and speed detector back to the axis control circuit 30, respectively, to perform feedback control on the position and speed. Note that, although only a single axis control circuit 30, only a single servo amplifier 40, and only a single servo motor 50 are illustrated in the hardware configuration diagram of FIG. 1, these components are each prepared for the number of axes of a machine to be controlled in the actual implementation.

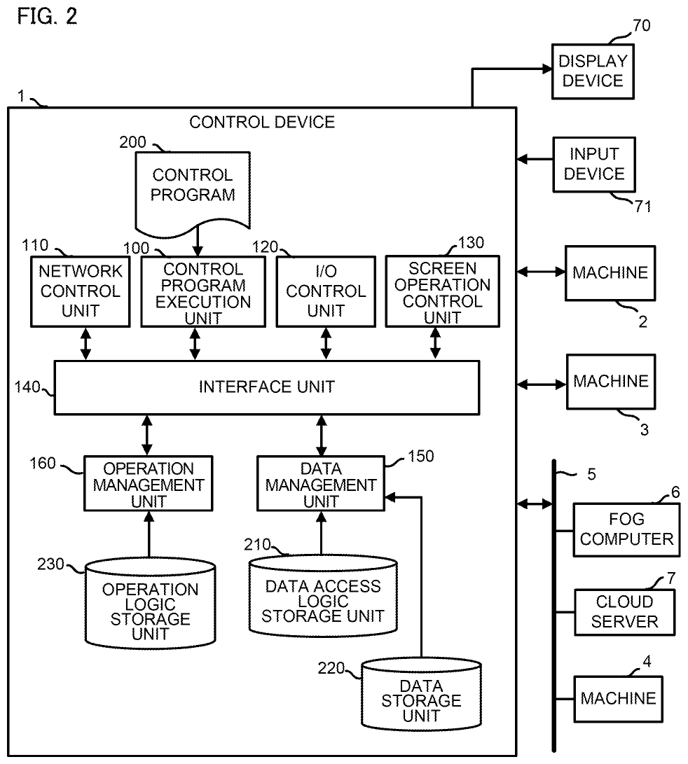

FIG. 2 illustrates the function of the control device 1 according to the first embodiment of the present invention as a schematic block diagram. Each function of the control device 1 according to the present embodiment is implemented when the CPU 11 of the control device 1 illustrated in FIG. 1 executes a system program to control the operation of each component of the control device 1.

The control device 1 of the present embodiment includes a control program execution unit 100, a network control unit 110, an I/O control unit 120, a screen operation control unit 130, an interface unit 140, a data management unit 150, and an operation management unit 160. Further, the RAM 13 or the nonvolatile memory 14 of the control device 1 stores a control program 200 such as a numerical control program (NC program) used for controlling machines 2, 3, and 4, peripheral devices, or the like and has a data access logic storage unit 210 that stores a data access logic used for referencing or updating data used in the function related to control of the machine 2, 3, or 4 to be controlled, a data storage unit 220 that is an area used for storing data acquired by the data access logic, and an operation logic storage unit 230 that stores an operation logic used for performing an operation that takes place in the function related to control of the machine 2, 3, or 4 to be controlled.

The control program execution unit 100 is implemented when the CPU 11 of the control device 1 illustrated in FIG. 1 executes a system program read from the ROM 12 to cause a calculation process using the RAM 13 or the nonvolatile memory 14 performed mainly by the CPU 11 and a process using the axis control circuit 30, the PLC 16, the interface 17 or 18, the interface 20, or the like to take place. The control program execution unit 100 analyzes the control program 200 and, based on the analysis result, controls the operation of the machine 2 controlled via the axis control circuit 30, the machine 3 controlled via the PLC 16, the machine 4 controlled via the network 5, or the like. The control program execution unit 100 creates and outputs instruction data used for controlling the machine 2, 3, or 4 based on an instruction to control the machine 2, 3, or 4 instructed by the control program 200, for example. In addition, the control program execution unit 100 acquires the state of the servo motor 50 (a current value, a position, a speed, an acceleration, a load, or the like of a motor) as a feedback value to use the acquired state in each control process. When accessing (referencing or updating) predetermined data related to the machine 2, 3, or 4, the control program execution unit 100 accesses the predetermined data via an interface provided by the interface unit 140. Further, when outputting data related to predetermined control to the machine 2, 3, or 4, the control program execution unit 100 outputs the data via an interface provided by the interface unit 140.

The network control unit 110 is implemented when the CPU 11 of the control device 1 illustrated in FIG. 1 executes a system program read from the ROM 12 to cause a calculation process using the RAM 13 or the nonvolatile memory 14 performed mainly by the CPU 11 and a process using the interface 20 or the like to take place. The network control unit 110 accesses data or inputs and outputs an instruction via a network. When accessing (referencing or updating) predetermined data related to the machine 2, 3, or 4 via the network 5, the network control unit 110 accesses the predetermined data via an interface provided by the interface unit 140. Further, when outputting an instruction related to predetermined control to the machine 2, 3, or 4 via the network 5, the network control unit 110 outputs the instruction via an interface provided by the interface unit 140.

The I/O control unit 120 is implemented when the CPU 11 of the control device 1 illustrated in FIG. 1 executes a system program read from the ROM 12 to cause a calculation process using the RAM 13 or the nonvolatile memory 14 performed mainly by the CPU 11 and a process using the PLC 16 or the like to take place. The I/O control unit 120 accesses data or inputs and outputs an instruction via the PLC 16. When accessing (referencing or updating) predetermined data related to the machine 2, 3, or 4 via the PLC 16, the I/O control unit 120 accesses the predetermined data via an interface provided by the interface unit 140. Further, when outputting an instruction related to predetermined control to the machine 2, 3, or 4 via the PLC 16, the I/O control unit 120 outputs the instruction via an interface provided by the interface unit 140.

The screen operation control unit 130 is implemented when the CPU 11 of the control device 1 illustrated in FIG. 1 executes a system program read from the ROM 12 to cause a calculation process using the RAM 13 or the nonvolatile memory 14 performed mainly by the CPU 11 and a process using the interface 17 or 18 or the like to take place. The screen operation control unit 130 performs control of display output to the display device 70 or input via the input device 71 as a user interface (UI). The screen operation control unit 130 acquires predetermined data to be displayed on the display device 70 via an interface provided by the interface unit 140.

The interface unit 140 is implemented when the CPU 11 of the control device 1 illustrated in FIG. 1 executes a system program read from the ROM 12 to cause a calculation process using the RAM 13 or the nonvolatile memory 14 performed mainly by the CPU 11 to take place. The interface unit 140 provides a mechanism of a common interface through which the data management unit 150 or the operation management unit 160 is used for the control program execution unit 100, the network control unit 110, the I/O control unit 120, and the screen operation control unit 130.

The common interface provided by the interface unit 140 and related to data access includes at least an interface used for data reference and an interface used for data update. For example, the interface used for data reference may be an interface that receives input of information for uniquely identifying a machine to be accessed and information for uniquely identifying a data item to be accessed and outputs a value of the data. For example, the interface used for data update may be an interface that receives input of information used for uniquely identifying a machine to be accessed, information for uniquely identifying a data item to be accessed, and a value of data to be updated and outputs whether or not to permit update of the data value. In response to receiving a request related to data access via the common interface, the interface unit 140 instructs the data management unit 150 to perform a process using a data access logic related to a designated machine.

Further, for example, the operation-related common interface provided by the interface unit 140 may be an interface that receives input of information for uniquely identifying a machine to be operated, information for uniquely identifying an operation, and a value of a parameter related to the operation and outputs whether or not to permit the operation. In response to receiving a request related to operation via the common interface, the interface unit 140 instructs the operation management unit 160 to perform a process using an operation logic related to a designated machine.

The data management unit 150 is implemented when the CPU 11 of the control device 1 illustrated in FIG. 1 executes a system program read from the ROM 12 to cause a calculation process using the RAM 13 or the nonvolatile memory 14 performed mainly by the CPU 11 and a process using the axis control circuit 30, the PLC 16, the interface 17 or 18, the interface 20, or the like to take place. The data management unit 150 manages access to data related to a machine to be controlled. Once access (referencing, update, or the like) to data related to a predetermined machine is requested, the data management unit 150 reads a data access logic related to the machine from the data access logic storage unit 210 to execute the data access logic and thereby accesses the data related to the machine.

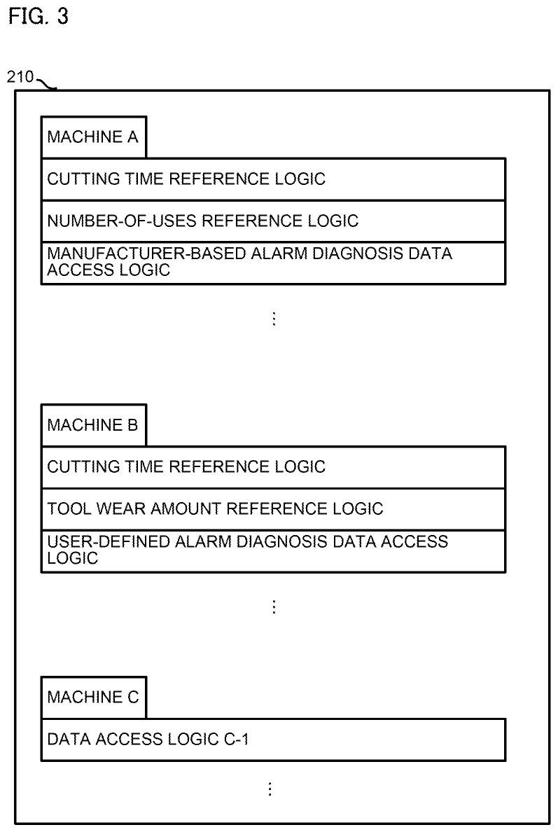

In the data access logic storage unit 210, as illustrated in FIG. 3 as an example, data access logics used for accessing data related to respective machines are stored in association with machines to be controlled. For example, the data access logic related to the machine 2 controlled by the control device 1 via the axis control circuit 30 includes an axis number when values of respective data items are referenced, a processing procedure for referencing a reading value, a procedure of conversion from a reading value into a reference value, or the like. For example, the data access logic related to the machine 3 controlled by the control device 1 via the PLC 16 includes signal addresses when values of respective data items are referenced, a processing procedure for referencing a signal value, a procedure of conversion from a signal value into a reference value, or the like. For example, the data access logic related to the machine 4 controlled by the control device via the network 5 includes a position of the machine on the network 5, addresses when values of respective data items are updated, a procedure of conversion from an update value into a reference value on the machine, a processing procedure for update, or the like.

Respective data access logics may be created by a subprogram or the like running on the CPU 11 or the PLC 16 of the control device 1. These data access logics may be created in advance by a machine manufacturer of a machine to be controlled or may be developed independently by the user of the machine. The data management unit 150 may execute a single data access logic to implement data access in response to an access request for a single data item. Further, the data management unit 150 may combine a plurality of data access logics and execute the combined data access logics in response to an access request for a single data item in accordance with a predetermined definition. This is used in a case where reference is made to a data value calculated based on data values related to a plurality of machines, a case where update of a single data value affects data related to a plurality of machines, or the like, for example. The definition of such a correspondence between an access request for data and a data access logic may be stored in advance in the data access logic storage unit 210.

The data management unit 150 may store and manage data related to a machine in the data storage unit 220. In such a case, the data management unit 150 searches the data storage unit 220 for the corresponding data in response to a request for data reference from the interface unit 140. Then, if the data is present, the data management unit 150 acquires and responds with the data stored in the data storage unit 220. In contrast, if the data is not present, the data management unit 150 acquires and responds with the data from the machine using the data access logic and stores the acquired data in the data storage unit 220. On the other hand, in response to a request for data update from the interface unit 140, the data management unit 150 updates data stored in the data storage unit 220 and uses the data access logic to update the data on the machine in parallel. When data is stored and managed in the data storage unit 220, an expiration period may be set for the stored data. For data that has expired, the data management unit 150 always uses the data access logic to acquire the data from the machine. The expiration period can be set larger for data whose value does not change unless a setting change or the like is made by an operator, and expiration period can be set smaller or zero (0) for data which changes in real time, such as a motor position or speed or the like.

The operation management unit 160 is implemented when the CPU 11 of the control device 1 illustrated in FIG. 1 executes a system program read from the ROM 12 to cause a calculation process using the RAM 13 or the nonvolatile memory 14 performed mainly by the CPU 11 and a process using the axis control circuit 30, the PLC 16, the interface 17, interface 18, the interface 20, or the like to take place. The operation management unit 160 manages execution of operation related to a machine to be controlled. In response to a request of execution of an operation related to a predetermined machine, the operation management unit 160 reads an operation logic related to the machine from the operation logic storage unit 230 to perform the operation related to the machine.

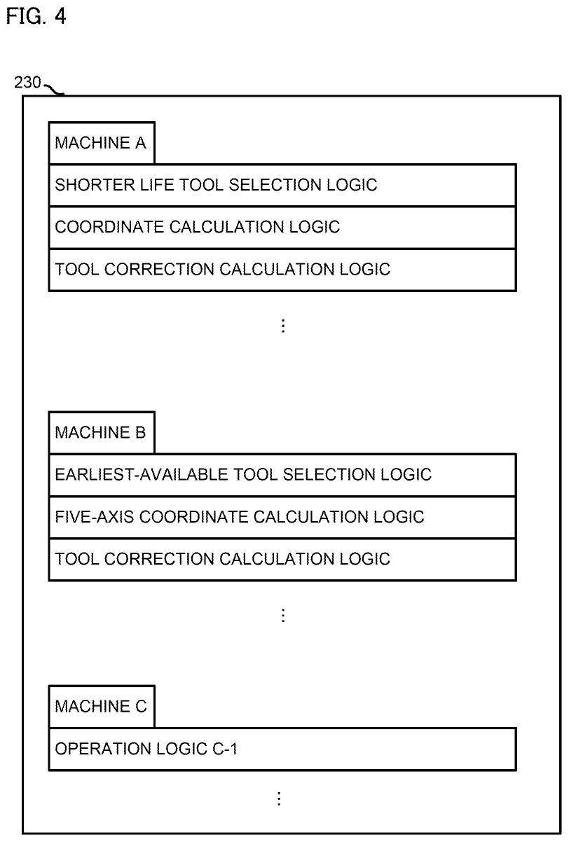

In the operation logic storage unit 230, operation logics including a procedure used for performing a predetermined control process are stored for respective machines, as illustrated in FIG. 4 as an example. In the operation logic storage unit 230, operation logics used for operating respective machines are stored in association with machines to be controlled. For example, the operation logic for performing a control process related to the machine 2 controlled by the control device 1 via the axis control circuit 30 includes an axis number used when a designated process is performed, a processing procedure for control, or the like. For example, the operation logic for performing a control process related to the machine 3 controlled by the control device 1 via the PLC 16 includes a signal address used when a designated process is performed, a processing procedure for control, or the like. For example, the operation logic for performing a control process related to the machine 4 controlled by the control device via the network 5 includes the position on the network 5 of the machine, a processing procedure for control, or the like.

Respective operation logics may be created by a subprogram or the like running on the CPU 11 or the PLC 16 of the control device 1. These operation logics may be created in advance by a machine manufacturer of a machine to be controlled or may be developed independently by the user of the machine. The operation management unit 160 may execute a single operation logic in response to a single operation execution request. Further, a plurality of operation logics may be combined with a single operation execution request for execution in accordance with a predetermined definition. When a plurality of operation logics are combined and executed, respective operation logics may be executed in an exclusive relationship. The definition of such a correspondence between an operation execution request and an operation logic may be stored in advance in the operation logic storage unit 230.

In the following, an example of data access and operation execution in the control device 1 having the above configuration will be described.

A case where two machines of a tool changer A (connected via the PLC 16) and a tool changer B (connected via the network 5) are control by the control device 1 is considered. In the data access logic storage unit 210, “cutting time reference access logic” and “number-of-uses reference logic” for the tool changer A are stored as the data access logic related to a tool life state of the tool changer A. Further, “cutting time reference access logic” and “tool wear amount reference access logic” for the tool changer B are stored in advance as the data access logic related to a tool life state of the tool changer B. Further, it is defined that, when a reference related to the tool life state is requested via the common interface, data access using “cutting time reference access logic” and “number-of-uses reference logic” is performed to respond in the tool changer A, and data access using “cutting time reference access logic” and “tool wear amount reference access logic” is performed to respond in the tool changer B.

At this time, it is assumed that a reference request related to “tool life state” of the tool changer A is received from an operation monitoring application running on the fog computer 6 that is the higher-level device (step SA01). In response, based on the request received from the higher-level PC, the network control unit 110 requests the interface unit 140 for data reference of “tool life state” of the tool changer A (step SA02). Once the interface unit 140 that has received the request requests the data management unit 150 to reference “tool life state” of the tool changer A (step SA03), the data management unit 150 reads “cutting time reference access logic” and “number-of-uses reference logic” for the tool changer A from the data access logic storage unit 210 and executes the read logics in order to reference “tool life state” of the tool changer A (step SA04). For respective data access logics, if the cutting time reference data and the number-of-uses reference data of the tool changer A are stored in the data storage unit 220, this is used for a response (step SA05). In contrast, if these data are not stored, a subprogram for referencing data related to the tool changer A is executed, the cutting time reference data and the number-of-uses reference data of the tool changer A are acquired via the PLC 16, and this is used for a response (step SA06).

On the other hand, it is assumed that a reference request related to “tool life state” of the tool changer B is received from the operation monitoring application running on the fog computer 6 that is a higher-level device (step SB01). In response, based on the request received from the higher-level PC, the network control unit 110 requests the interface unit 140 to reference data of “tool life state” of the tool changer B (step SB02). Once the interface unit 140 that has received the request requests the data management unit 150 to reference “tool life state” of the tool changer B (step SB03), the data management unit 150 reads “cutting time reference access logic” and “tool wear amount reference access logic” for the tool changer B from the data access logic storage unit 210 and executes the read logics in order to reference “tool life state” of the tool changer B (step SB04). For respective data access logics, if the cutting time reference data and the tool wear amount reference data of the tool changer B are stored in the data storage unit 220, this is used for a response (step SB05). In contrast, if these data are not stored, a subprogram for referencing data related to the tool changer B is executed, the cutting time reference data and the tool wear amount reference data of the tool changer B are acquired via the network 5, and this is used for a response (step SB06).

As another example, in the operation logic storage unit 230, “shorter life tool selection logic” for the tool changer A (where a tool having the shortest life is selected) is stored as an operation logic related to tool selection operation of the tool changer A. Further, “earliest-available tool selection logic” for the tool changer B (where a tool that can be transported at the earliest time is selected) is stored in advance as an operation logic related to tool selection operation of the tool changer B. Further, it is defined that, when an execution request for a tool selection operation is received via the common interface, tool selection using “shorter life tool selection logic” is executed in the tool changer A, and tool selection using “earliest-available tool selection logic” is executed in the tool changer B.

At this time, it is assumed that a tool selection instruction (T_) is provided in the control program 200 and executed by the control program execution unit 100 (step SC01). The control program execution unit 100 requests the interface unit 140 to perform “tool selection operation” of the tool changer A based on the execution of the tool selection instruction (step SC02). The interface unit 140 that has received the request requests the operation management unit 160 to perform “tool selection operation” of the tool changer A (step SC03), and in response, the operation management unit 160 reads “shorter life tool selection logic” for the tool changer A from the operation logic storage unit 230 and executes the read logic in order to perform the “tool selection operation” of the tool changer A (step SC04). In accordance with this operation logic, the subprogram for searching for and selecting a shorter life tool is executed for the tool changer A. The subprogram acquires the life of each tool via the PLC 16 from the tool changer A or via the data management unit 150 to determine a shorter life tool. The tool changer A is then instructed via the PLC 16 to select the determined shorter life tool (step SC05).

On the other hand, it is assumed that a tool selection instruction (T_) is provided in the control program 200 and executed by the control program execution unit 100 (step SD01). The control program execution unit 100 requests the interface unit 140 to perform “tool selection operation” of the tool changer B based on the execution of the tool selection instruction (step SD02). The interface unit 140 that has received the request requests the operation management unit 160 to perform “tool selection operation” of the tool changer B (step SD03), and in response, the operation management unit 160 reads “earliest-available tool selection logic” for the tool changer B from the operation logic storage unit 230 and executes the read logic in order to perform the “tool selection operation” of the tool changer B (step SD04). In accordance with this operation logic, the subprogram for searching for and selecting the earliest available tool is executed for the tool changer B. The subprogram acquires the location of each tool via the network 5 from the tool changer B or via the data management unit 150 to determine the earliest available tool. The tool changer B is then instructed via the network 5 to select the determined tool (step SD05).

As yet another example, a case where two machines of a three-axis control machine tool A (connected via the PLC 16) and a five-axis control machine tool B (connected via the network 5) are controlled by the control device 1 is considered. In the data access logic storage unit 210, “manufacturer-based alarm diagnosis data access logic” for the machine tool A is stored as a data access logic related to alarm diagnosis information on the machine tool A. Further, “user-defined alarm diagnosis data access logic” for the machine tool B is stored in advance as a data access logic related to alarm diagnosis information on the machine tool B. Further, it is defined that, when a reference related to the alarm diagnosis information is requested via the common interface, data access using “manufacturer-based alarm diagnosis data access logic” is executed to respond in the machine tool A, and data access using “user-defined alarm diagnosis data access logic” is executed to respond in the machine tool B.

At this time, it is assumed that the screen operation control unit 130 of the control device 1 intends to display a diagnosis window of an alarm of the machine tool A on the display device 70 (step SE01). The screen operation control unit 130 requests the interface unit 140 to reference data related to “alarm diagnosis information” on the machine tool A as information required for screen display (step SE02). The interface unit 140 that has received the request requests the data management unit 150 to reference “alarm diagnosis information” on the machine tool A (step SE03), and in response, the data management unit 150 reads “manufacturer-based alarm diagnosis data access logic” for the machine tool A from the data access logic storage unit 210 and executes the read logic in order to reference the “alarm diagnosis information” on the machine tool A (step SE04). For this data access logic, if alarm diagnosis information set by the manufacturer of the machine tool A is stored in the data storage unit 220, this is used for a response (step SE05). In contrast, if such alarm diagnosis information is not stored, a subprogram for referencing data related to the machine tool A is executed, alarm diagnosis information set by the manufacturer is acquired from the machine tool A via the PLC 16, and this is used for a response (step SE06).

On the other hand, it is assumed that the screen operation control unit 130 of the control device 1 intends to display a diagnosis window of an alarm of the machine tool B on the display device 70 (step SF01). The screen operation control unit 130 requests the interface unit 140 to reference data related to “alarm diagnosis information” on the machine tool B as information required for screen display (step SF02). The interface unit 140 that has received the request requests the data management unit 150 to reference “alarm diagnosis information” on the machine tool B (step SF03), and in response, the data management unit 150 reads “user-defined alarm diagnosis data access logic” for the machine tool B from the data access logic storage unit 210 and executes the read logic in order to reference the “alarm diagnosis information” on the machine tool B (step SF04). For this data access logic, if alarm diagnosis information set by the user of the machine tool B is stored in the data storage unit 220, this is used for a response (step SF05). In contrast, if such alarm diagnosis information is not stored, a subprogram for referencing data related to the machine tool B is executed, alarm diagnosis information set by the user is acquired from the machine tool B via the network 5, and this is used for a response (step SF06).

As yet another example, in the operation logic storage unit 230, “coordinate calculation logic”, “tool correction calculation logic”, and “tool path rendering logic” for the machine tool A are stored in advance as operation logics related to tool path rendering of the machine tool A, and “five-axis coordinate calculation logic”, “tool correction calculation logic”, “thermal displacement correction calculation logic”, and “tool path rendering logic” for the machine tool B are stored in advance as operation logics related to tool path rendering of the machine tool B. Further, it is defined that, when an execution request for tool path rendering is received via the common interface, the “coordinate calculation logic”, “tool correction calculation logic”, and “tool path rendering logic” are sequentially executed to perform a tool path rendering process in the machine tool A, and on the other hand, the “five-axis coordinate calculation logic”, “tool correction calculation logic”, “thermal displacement correction calculation logic”, and “tool path rendering logic” are sequentially executed to perform a tool path rendering process in the machine tool B.

At this time, it is assumed that a request for executing “tool path rendering” of the machine tool A is received from a state monitoring application running on the fog computer 6 that is the higher-level device (step SG01). The network control unit 110 requests the interface unit 140 to execute the “tool path rendering” of the machine tool A (step SG02). The interface unit 140 that has received the request requests the operation management unit 160 to execute the “tool path rendering” of the machine tool A (step SG03), and in response, the operation management unit 160 sequentially reads the “coordinate calculation logic”, “tool correction calculation logic”, and “tool path rendering logic” for the machine tool A from the operation logic storage unit 230 and executes the read logics in order to perform the “tool path rendering” of the machine tool A (step SG04). In accordance with this operation logic, calculation of the coordinate position of the machine tool A, calculation of tool correction, and a tool path rendering process based on the calculated coordinate value and the tool correction value are sequentially performed. A result of rendering calculation is then provided as a response to the higher-level device via the interface unit 140 (step SG05).

On the other hand, it is assumed that a request for executing “tool path rendering” of the machine tool B is received from the state monitoring application running on the fog computer 6 that is the higher-level device (step SH01). The network control unit 110 requests the interface unit 140 to execute the “tool path rendering” of the machine tool B (step SH02). The interface unit 140 that has received the request requests the operation management unit 160 to execute the “tool path rendering” of the machine tool B (step SH03), the operation management unit 160 sequentially reads the “five-axis coordinate calculation logic”, “tool correction calculation logic”, “thermal displacement correction calculation logic”, and “tool path rendering logic” for the machine tool B from the operation logic storage unit 230 and executes the read logics in order to perform the “tool path rendering” of the machine tool B (step SH04). In accordance with this operation logic, calculation of the coordinate position taking the inclination of the spindle or the like into consideration of the machine tool B, calculation of tool correction, calculation of thermal displacement correction, and a tool path rendering process based on a calculated coordinate value, a tool correction value, and a thermal displacement correction value are sequentially performed. A result of rendering calculation is then provided as a response to the higher-level device via the interface unit 140 (step SH05).

As described above, in the control device 1 having the above configuration, control of a machine using a data access logic or an operation logic can be performed for each machine to be controlled. Since data access or operation performed on the machine is performed via the common interface provided by the interface unit 140, a developer of an application or the like may easily perform data access or control on machines having different specifications if the developer remembers the specification of the common interface. Differences in the specifications between machines or differences in accessories such as tools are absorbed by the data access logic or the operation logic executed by the data management unit 150 and the operation management unit 160. Since an operator on site may use the common interface to control a machine or develop its original application used for maintenance or management, the development efficiency is improved, and maintenance of a facility is expected to be improved.

Although one embodiment of the present invention has been described above, the present invention is not limited to only the example of the embodiments described above and can be implemented in various forms with addition of suitable modification.

### LIST OF REFERENCE SYMBOLS

1 control device
2, 3, 4 machine
5 network
6 fog computer
7 cloud server
11 CPU
12 ROM
13 RAM
14 nonvolatile memory
17, 18, 20 interface
16 PLC
19 I/O unit
22 bus
30 axis control circuit
40 servo amplifier
50 servo motor
70 display device
71 input device
72 external device
100 control program execution unit
110 network control unit
120 I/O control unit
130 screen operation control unit
140 interface unit
150 data management unit
160 operation management unit
200 control program
210 data access logic storage unit
220 data storage unit
230 operation logic storage unit

1. A control device that controls an industrial machine, the control device comprising:
a data access logic storage unit that stores at least one data access logic used for performing at least any one of reference and update of data related to the industrial machine;
a data management unit that, based on the data access logic, performs at least any one of reference and update of the data related to the industrial machine;
an operation logic storage unit that stores at least one operation logic used for performing a control process of the industrial machine;
an operation management unit that, based on the operation logic, performs an operation related to the industrial machine; and
an interface unit that provides a common interface used for accessing the data management unit and the operation management unit,
wherein a function related to the industrial machine is available via the common interface.

2. The control device according to claim 1, wherein the function is at least any one of a function of performing an operation related to a tool used in the industrial machine, a function of accessing data related to the tool, and a function of life management related to the tool.
